(19) United States
(12) Patent Application Publication
(10) Pub. No.: US 2014/0083140 A1
(43) Pub. Date: Mar. 27, 2014

(54) METHOD OF MANUFACTURING POROUS GLASS DEPOSITION BODY FOR OPTICAL FIBER

(71) Applicant: SHIN-ETSU CHEMICAL CO., LTD., Tokyo (JP)

(72) Inventor: Yuhei URATA, Gunma (JP)

(73) Assignee: SHIN-ETSU CHEMICAL CO., LTD., Tokyo (JP)

(21) Appl. No.: 14/029,798

(22) Filed: Sep. 18, 2013

(30) Foreign Application Priority Data
Sep. 24, 2012 (JP) 2012-209297

(51) Int. Cl. C03B 37/014

(52) U.S. Cl. CPC C03B 37/0142
USPC 65/414

(57) ABSTRACT

To provide a method for manufacturing a porous glass deposition body for optical fiber without causing deposition unevenness or decreasing the yield, provided is a method of manufacturing a porous glass deposition body by blowing glass fine particles generated from a plurality of burners for glass fine particle synthesis onto a starting member that is moved vertically and rotated on a rotational axis that is a central axis of the starting member. The burners are arranged such that the central axis of each burner shares a plane with the rotational axis of the starting member, and at least two of the planes in which the central axis of one of the burners and the rotational axis of the starting member are arranged form a prescribed angle.

The contents of the following Japanese patent application are incorporated herein by reference: No. 2012-209297 filed on Sep. 24, 2012.

### BACKGROUND

1. Technical Field

The present invention relates to a method of manufacturing a porous glass deposition body to serve as a precursor of synthetic quartz glass for optical fiber, and particularly to a method of manufacturing a porous glass deposition body (referred to hereinafter as “soot”) while depositing glass fine particles on the outside of a starting member being rotated and moved vertically.

2. Related Art

There is a method for manufacturing soot by affixing glass fine particles generated in the flame of a burner to a starting member that is raised vertically while being rotated. This method includes supplying silicon chloride such as silicon tetrachloride in an oxyhydrogen flame and attaching/depositing the glass fine particles generated by the flame hydrolysis reaction and the high temperature oxidation reaction onto the starting member. The manufactured soot is made transparent by being heated and sintered in a vacuum or inert gas atmosphere, thereby forming synthetic quartz glass for use as optical fiber.

In the optical fiber, light can be propagated by slightly increasing the refractive index of the central portion (core) relative to the outer portion (cladding). In order to increase the refractive index, a method is generally used that includes doping with germanium oxide. The germanium oxide is implanted during the manufacturing of the soot. Therefore, when manufacturing the soot that is to serve as a precursor of synthetic quartz glass for optical fiber, a burner for depositing the core and a burner for depositing the cladding are used separately. The burner for depositing the core is supplied with germanium chloride along with the silicon compound.

In this way, a plurality of burners are used when manufacturing soot including a core. Another reason for using a plurality of burners is to increase the amount of glass fine particles that are deposited per unit time. In order to improve production during the soot manufacturing it is necessary to increase the deposition efficiency (the ratio of glass fine particles that become attached to the amount of raw material supplied) by increasing the amount of glass fine particles attached. When a plurality of burners are used, interference between the flames of adjacent burners must be considered. If there is too much interference between the flames, the deposition efficiency decreases because the surface area on which the flame applies soot is narrower. If there is not enough interference, the firing of the soot is weakened and a low density portion occurs, which is a cause of outer diameter fluctuation and cracking due to the density difference.

When the burners are arranged at small intervals, i.e. when adjacent burners are near each other, in order to improve production, the expansion of the flames causes adjacent flames to interfere greatly with each other. The deposition of glass fine particles is impeded at the border region where the interference occurs, and this causes uneven deposition and lowers the deposition speed of the glass fine particles. The unevenness causes the flow of the flames to be unstable, and this results in even more deposition unevenness. As a result, fluctuation in the outer diameter of the soot occurs easily and the yield is decreased.

When there is fluctuation in the outer diameter of the soot, this outer diameter fluctuation remains after the sintering and transparent vitrification. Depending on the amount of outer diameter fluctuation, it can be difficult to eliminate this fluctuation with a glass lathe during the drawing process, and even if this fluctuation can be eliminated the machining cost is increased.

### SUMMARY

In light of the above problems, it is an objective of the present invention to provide a method for manufacturing a porous glass deposition body for optical fiber without causing deposition unevenness or decreasing the yield.

The problems described above can be solved using the following method. A method of manufacturing a porous glass deposition body for an optical fiber by blowing glass fine particles generated from a plurality of burners for glass fine particle synthesis onto a starting member that is moved vertically and rotated on a rotational axis that is a central axis of the starting member. The burners are arranged such that the central axis of each burner shares a plane with the rotational axis of the starting member, and at least two of the planes in which the central axis of one of the burners and the rotational axis of the starting member are arranged form a prescribed angle.

The summary clause does not necessarily describe all necessary features of the embodiments of the present invention. The present invention may also be a sub-combination of the features described above.

### BRIEF DESCRIPTION OF THE DRAWINGS

FIG. 1 shows burners 1 and 2 arranged at angles differing by θ relative to the central axis of a starting member, as seen from below the soot being deposited.

FIG. 2 shows the soot being deposited as seen facing a plane formed by the central axis of the burner 1 and the rotational axis of the starting member.

FIG. 3 is a graph showing the relationship between θ and the deposition rate in the first embodiment.

FIG. 4 is a graph showing the relationship between θ and the diameter fluctuation rate in the first embodiment.

FIG. 5 is a graph showing the relationship between θ and the deposition rate in the second embodiment.

FIG. 6 is a graph showing the relationship between θ and the diameter fluctuation rate in the second embodiment.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

In the present embodiment, the burners are arranged such that the central axis of each burner shares a plane with the rotational axis of the starting member, and at least two of the planes in which the central axis of one of the burners and the rotational axis of the starting member are arranged form a prescribed angle. The angles formed by the at least two planes are different angles and each no less than 3 degrees and no greater than 30 degrees, more preferably no less than 5 degrees and no more than 30 degrees. If this angle is less than 3 degrees, the flames interfere greatly with each other and the deposition of the glass fine particles is impeded, thereby causing unevenness in the deposition. If this angle is greater than 30 degrees, the interference between the flames is weakened and the firing becomes unstable, which causes diameter fluctuation in the longitudinal direction due to low density portions.

The intersections between the rotational axis of the starting member and central axis lines of the burners are distanced from each other vertically, and it is preferable that the vertical distance between the intersections be from 25% to 100% of a deposition body target diameter. In this way, each burner serves a different role in the deposition, and a complex refractive index profile can be realized. If the distance between these intersections is less than 25% of the target diameter, there is too much interference between the flames. If the distance between these intersections is greater than 100% of the target diameter, the firing effect of the flame is weakened because the deposition zone is longer than necessary, and therefore undesirable cracking is more likely to occur in the soot. By arranging three or more burners, the deposition amount per unit time can be greatly improved. Furthermore, by using a configuration in which three or more of the burners are arranged, an angle formed by two of the planes is 3 degrees or more, an angle formed by another two of the planes is 3 degrees or more, an angle formed by yet another two of the planes is 6 degrees or more, and an angle formed by the two planes of adjacent burners is 30 degrees or less, the deposition rate can be improved while restricting diameter fluctuation in the longitudinal direction.

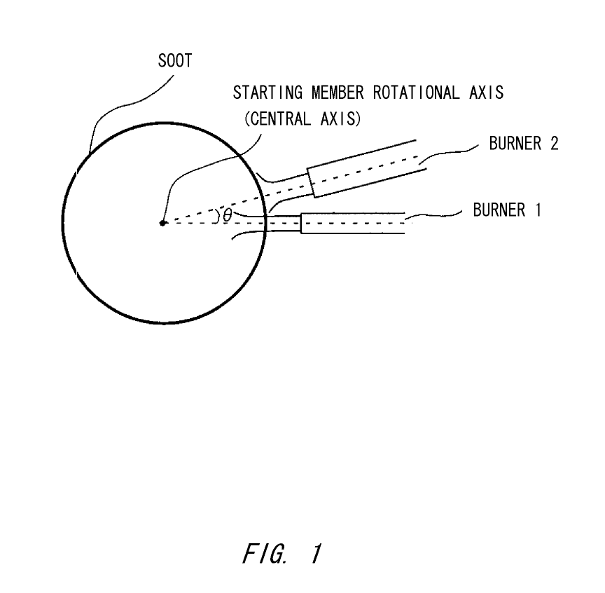

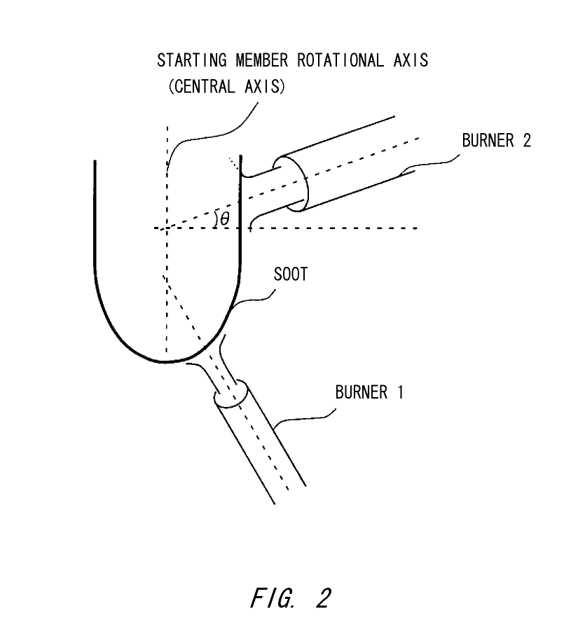

FIG. 1 shows burners 1 and 2 arranged at angles differing by θ relative to the central axis of a starting member, as seen from below the soot being deposited. FIG. 2 shows the soot being deposited as seen facing a plane formed by the central axis of the burner 1 and the rotational axis of the starting member. In this way, each burner is directed toward the center of the soot. At least one of the burners is arranged to be oriented toward the rotational axis of the starting member with a different angle than the other burner. By performing deposition with this arrangement, interference between flames can be restricted while enabling the burners to be arranged closely together in a manner to avoid density differences in the longitudinal direction. As a result, the deposition rate can be improved. Furthermore, since there is little interference between the flames, deposition unevenness can be restricted and outer diameter fluctuation can be prevented.

### EMBODIMENTS

### First Embodiment

VAD was applied using three burners, to manufacture soot with a length of 1500 mm and a diameter of 120 mm (deposition target diameter). Each burner has its central axis arranged to face the rotational axis of the starting member, and each burner is arranged such that the distance between intersection points formed between a central axis line of the burner and the rotational axis of the starting member is 40 mm for the distance between the lower core deposition burner and the first cladding deposition burner adjacent thereabove and 100 mm for the distance between the first cladding deposition burner and the second cladding deposition burner adjacent thereabove. The burners are arranged such that, among the three planes formed by the rotational axis of the starting member and the central axes of the burners, only the surface formed by the rotational axis of the starting member and the central axis of the first cladding deposition burner forms an angle θ with respect to the other two planes.

The core deposition burner was supplied with 0.4 liters per minute of SiCl₄, 4 liters per minute of hydrogen, 0.25 liters per minute of argon, and 7 liters per minute of oxygen in the stated order from a central tube thereof. The first cladding deposition burner was supplied with 0.85 liters per minute of SiCl₄, 18 liters per minute of hydrogen, 1.1 liters per minute of argon, and 16 liters per minute of oxygen in the stated order from a central tube thereof. The second cladding deposition burner was supplied with 4 liters per minute of SiCl₄, 55 liters per minute of hydrogen, 2.5 liters per minute of argon, and 35 liters per minute of oxygen in the stated order from a central tube.

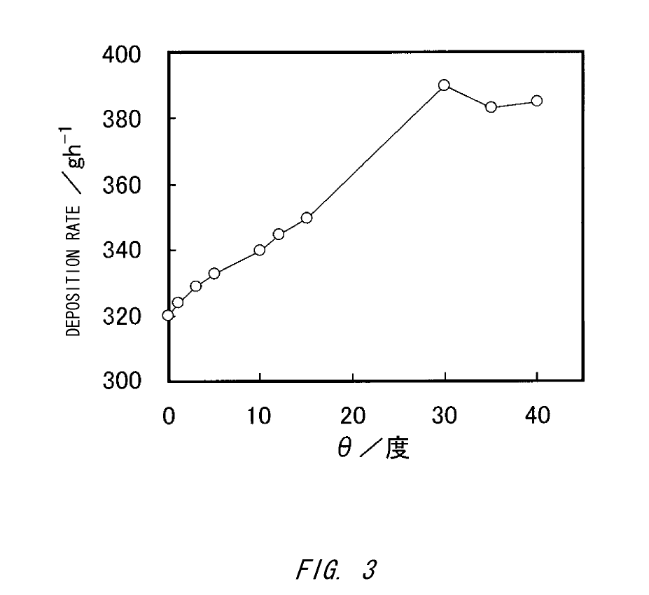

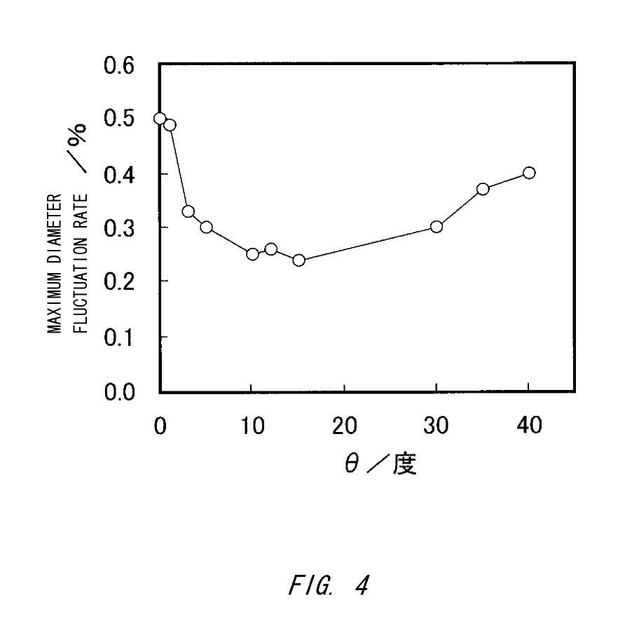

The deposition was performed while changing the angle θ between 0 and 40 degrees. The relationship between θ and the deposition rate is shown in FIG. 3, and the relationship between θ and the diameter fluctuation rate is shown in FIG. 4. Based on FIG. 3, it is understood that the deposition rate of the glass deposition body is improved by increasing the angle θ to be greater than 0 degrees, but also that the deposition rate of the glass deposition body begins to decrease when θ exceeds 30 degrees.

Based on FIG. 4, it is understood that the maximum diameter fluctuation rate can be restricted to 0.35% or less by setting θ to be no less than 3 degrees and no greater than 30 degrees. Although the outer diameter fluctuation is corrected through lathe machining, the correction target should have a maximum diameter fluctuation change of 0.35% or more, and therefore setting θ to be no less than 3 degrees and no greater than 30 degrees is a suitable solution to the outer diameter fluctuation.

The diameter fluctuation rate is calculated as shown by Expression 1 below.

Fluctuation Rate=(D−D_{avg})/D_{avg}×100(%) Expression 1

Here, D is outer diameter at each point on the deposition body, and D_{avg} is the average value of the outer diameter in a stationary portion of the deposition body. The outer diameter fluctuation is evaluated according to the maximum diameter fluctuation rate, which is the largest value among the diameter fluctuation rates calculated for each point.

### Second Embodiment

VAD was applied using three burners, to manufacture soot with a length of 1500 mm and a diameter of 120 mm (deposition target diameter). Each burner has its central axis arranged to face the rotational axis of the starting member, and each burner is arranged such that the distance between intersection points formed between a central axis line of the burner and the rotation axis of the starting member is 40 mm for the distance between the lower core deposition burner and the first cladding deposition burner adjacent thereabove and 100 mm for the distance between the first cladding deposition burner and the second cladding deposition burner adjacent thereabove. The burners were arranged such that, among the three planes formed by the rotational axis of the starting member and the central axes of the burners, only the surface formed by the rotational axis of the starting member and the central axis of the second cladding deposition burner forms an angle θ with respect to the other two planes. The type and amount of supplied gases were the same as in the first embodiment.

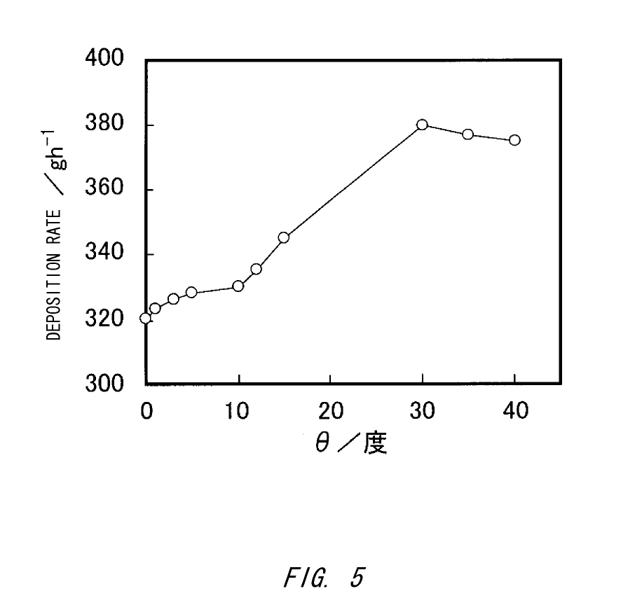

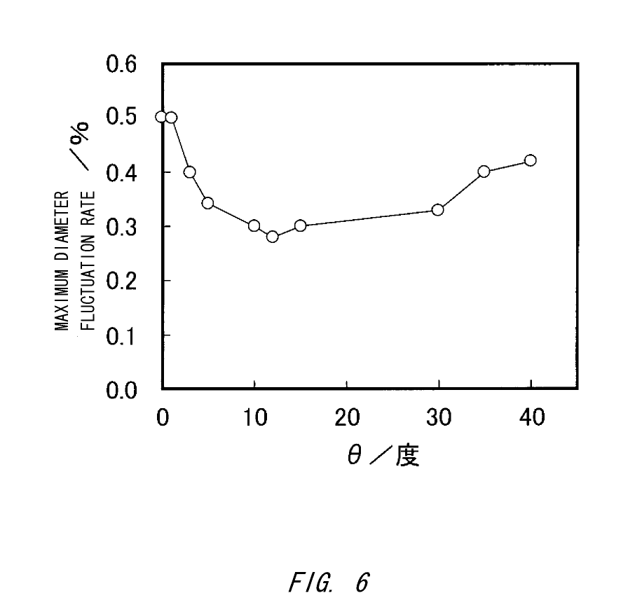

In the same manner as in the first embodiment, the deposition was performed while changing the angle θ between 0 and 40 degrees. The relationship between 0 and the deposition rate is shown in FIG. 5, and the relationship between 0 and the diameter fluctuation rate is shown in FIG. 6. Based on FIG. 5, it is understood that the deposition rate of the glass deposition body is improved by increasing the angle θ to be greater than 0 degrees, but also that the deposition rate of the glass deposition body begins to decrease when 0 exceeds 30 degrees.

Based on FIG. 6, it is understood that the maximum diameter fluctuation rate can be restricted to 0.35% or less by setting θ to be no less than 3 degrees and no greater than 30 degrees. It is understood that, in consideration of the decrease in the diameter fluctuation rate, θ is preferably no less than 3 degrees, more preferably no less than 5 degrees. Based on the results from the first and second embodiments, by setting the orientation angle of only a portion of the burners to be no less than 3 degrees and no greater than 30 degrees, the maximum diameter fluctuation rate can be restricted to be no greater than 0.35% and the deposition rate of the glass deposition body can be improved.

### Third Embodiment

VAD was applied using three burners, to manufacture soot with a length of 1500 mm and a diameter of 120 mm (deposition target diameter). Each burner has its central axis arranged to face the rotational axis of the starting member, and each burner is arranged such that the distance between intersection points formed between a central axis line of the burner and the rotation axis of the starting member is 4 mm for the distance between the lower core deposition burner and the first cladding deposition burner adjacent thereabove and 100 mm for the distance between the first cladding deposition burner and the second cladding deposition burner adjacent thereabove.

The burners were arranged such that the plane formed by the rotational axis of the starting member and the central axis of the core deposition burner and the plane formed by the rotational axis of the starting member and the central axis of the first cladding deposition burner have an angle of 5 degrees therebetween, the plane formed by the rotational axis of the starting member and the central axis of the core deposition burner and the plane formed by the rotational axis of the starting member and the central axis of the second cladding deposition burner have an angle of 5 degrees therebetween, and the plane formed by the rotational axis of the starting member and the central axis of the first cladding deposition burner and the plane formed by the rotational axis of the starting member and the central axis of the second cladding deposition burner have an angle of 10 degrees therebetween. The type and amount of gases supplied to each burner were the same as in the first and second embodiments.

As a result, the manufactured soot had a high deposition rate of 345 gh⁻¹ and a low maximum diameter fluctuation rate of 0.25%.

As described above, the burners are arranged such that the central axis of each burner shares a plane with the rotational axis of the starting member, and at least two of the planes in which the central axis of one of the burners and the rotational axis of the starting member are arranged form a prescribed angle. At least two of these planes form different angles that are no less than 3 degrees and no more than 30 degrees, more preferably no less than 5 degrees and no more than 30 degrees. As a result, the burners can be arranged to reduce the interference between the flames of the burners, thereby improving the deposition rate and the overall production, and also reducing defects such as cracking or external deformation of the soot.

Furthermore, when outer diameter fluctuation occurs in the soot, the outer diameter fluctuation remains after the sintering and transparent vitrification. Depending on the amount of outer diameter fluctuation, it can be difficult to eliminate this fluctuation with a glass lathe during the drawing process, and even if this fluctuation can be eliminated the machining cost is increased. Accordingly, the machining cost can be reduced by restricting the external fluctuation of the soot.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

What is claimed is:

1. A method of manufacturing a porous glass deposition body by blowing glass fine particles generated from a plurality of burners for glass fine particle synthesis onto a starting member that is moved vertically and rotated on a rotational axis that is a central axis of the starting member, wherein
the burners are arranged such that the central axis of each burner shares a plane with the rotational axis of the starting member, and at least two of the planes in which the central axis of one of the burners and the rotational axis of the starting member are arranged form a prescribed angle.

2. The method according to claim 1, wherein
an angle formed by the at least two planes is no less than 3 degrees and no greater than 30 degrees.

3. The method according to claim 1, wherein
intersections between the rotational axis of the starting member and central axis lines of the burners are distanced from each other vertically.

4. The method according to claim 3, wherein
the vertical distance between the intersections is from 25% to 100% of a deposition body target diameter.

5. The method according to claim 1, wherein three of more of the burners are arranged.

6. The method according to claim 1, wherein
three or more of the burners are arranged,
an angle formed by two of the planes is 3 degrees or more,
an angle formed by another two of the planes is 3 degrees or more,
an angle formed by yet another two of the planes is 6 degrees or more, and
an angle formed by the two planes of adjacent burners is 30 degrees or less.
